(19) United States
(12) Patent Application Publication
(10) Pub. No.: US 2016/0278372 A1
(43) Pub. Date: Sep. 29, 2016

(54) TINY PARTICLES FOR CONTROL-RELEASE AND METHOD OF MANUFACTURING THE SAME

(71) Applicant: Andrew TENG, Saratoga, CA (US)

(72) Inventor: Andrew TENG, Saratoga, CA (US)

(21) Appl. No.: 15/077,866

(22) Filed: Mar. 22, 2016

Related U.S. Application Data
(60) Provisional application No. 62/139,624, filed on Mar. 27, 2015.

(51) Int. Cl. A01N 25/30

(52) U.S. Cl. CPC A01N 25/30

(57) ABSTRACT

The present invention provides a tiny particle for control-release and method of manufacturing the same. The tiny particle comprises algae extracts and divalent metal ions, and forms a complex by cross-linking. The present invention is able to produce the control release particle that meets user's needs by controlling cross-linking time. In addition, if a surfactant is added, the time for control release can be increased. Therefore, this is an unexpected result.

### CROSS-REFERENCE TO RELATED APPLICATION

This application claims a priority benefit under 35 U.S.C. §119(e) from U.S. Patent Application No. 62/139,624, filed Mar. 27, 2015, which is incorporated herein by reference.

### BACKGROUND OF THE INVENTION

1. Field of the Invention

The present invention generally relates to a tiny particle, in particular to a tiny particle capable of controlling release a substance and manufacturing thereof.

2. Description of the Related Art

According to the definition from Controlled Release Society (CRS), controlled release is a term referring to the presentation or delivery of compounds in response to stimuli or time. This can be for purposes in several areas including agriculture, cosmetics and personal care, pharmaceuticals and food science. The purpose of controlled release is not only prolonging action but also attempting to maintain drug levels within the therapeutic window to avoid potentially hazardous peaks in drug concentration following ingestion or injection and to maximize therapeutic efficiency and to minimize the side effect.

Recently, it is found that controlled release system or sustained release system is better than dump system. Lots of mechanisms about controlled release system are discovered and developed by professionals in this field. There are seven categories about controlled release described as follows.

(a) Diffusion-Control System (also called “Reservoir Device”): It is the simplest diffusion controlled release device. The active agent is released out to environment by diffusion, through the micropores of the capsule walls. The active agent is surrounded or encapsulated by a thin layer of polymeric membrane.

(b) Matrix Diffusion System: the active agent is evenly dispersed or dissolved in the polymer in this system. Release of the active agent may take place either by diffusion or leaching along with diffusion if there is interaction between polymer matrix and the environment. If a soluble additive is incorporated in the polymer matrix, the surrounding fluid can easily penetrate the matrix by dissolving the additive to form interconnected channels.

(c) Swelling-Controlled System: the dispersed or dissolved active agent in polymer matrix is unable to diffuse to any considerable extent. The active agent is released out slowly when the polymer system gets into contact with a compatible solvent or fluid in the environment and swelling takes place.

(d) Erosion-Controlled System: the release of the active agent occurs here by erosion of the polymer. The active agent is physically immobilized in the polymer matrix. The release rate of the active agent is generally proportional to the erosion rate of the polymer matrix which undergoes surface erosion. The pH-sensitive polymer matrix can be a carrier and be eroded within specific pH range. A zero order release rate can be achieved in these systems if the erosion rate is constant and matrix dimension remains unchanged.

(e) Chemically-Controlled System: the active agent will be released only when the bond to the polymer is cleaved or the polymer is degraded. A zero order release profile may be achieved when the active agent is a co-monomeric unit in polymer backbone and release occur by polymer degradation.

(f) Chemically-Controlled System: the system changes the chemical structure when exposed to biological fluid. Mostly, biodegradable polymers are designed to degrade as a result of hydrolysis of the polymer chains into biologically safe and progressively smaller moieties.

(g) Osmotic Pumps System: Osmotic force is the driving force in osmosis-controlled systems. Such systems generally consist of a solid and water-soluble active agent, which is enclosed by a water-permeable, but active agent impermeable membrane with a small opening. When water is transported into the core by permeation, hydrostatic pressure will be built up in the core subsequently and drive dissolved active agent coming out through the small opening.

US. Patent No. 20100112050 disclosed a biodegradable, water soluble film for delivering pharmaceutically active agents, and methods for administering pharmaceutically active agents to patients. However, it lacks the ability of releasing active agents for a very long period of time.

Taiwan Patent No. 201136620 disclosed a controlled-release capsule of pearl powder comprising a pearl powder and a granular carrier with a shell and an internal space defined by the shell. However, this conventional technology has limitation in the size of releasing agents. Moreover, the release period of the conventional technology is less than 30 hours.

Present invention discloses a tiny particle which can release inclusions stably to achieve a long term or short term effect by using natural molecules.

### SUMMARY OF THE INVENTION

The primary objective of the present invention is to provide a method for manufacturing a membrane for controlled release purpose. An algae extract aqueous solution and an aqueous solution having divalent metal ion can be used to form a micro or nano size complex by cross-linking reaction, and the complex can be used in different release condition by manufacturing that in different process.

Therefore, to achieve the foregoing objective, the present invention provides a method for manufacturing a controlled release membrane, comprising following steps: (a) adding an aqueous solution having divalent metal ion to targeted materials. (b) utilizing an algae extract to prepare an algae extract aqueous solution; (c) stirring the algae extract aqueous solution; and (d) adding algae extract aqueous solution to target material from process (a).

To achieve the foregoing objective, the present invention further provides another method for manufacturing a controlled release membrane, comprising following steps: (a) adding an aqueous solution having divalent metal ion to targeted materials. (b) utilizing an algae extract to prepare an algae extract aqueous solution; (c) adding a surfactant to the algae extract aqueous solution; (d) stirring the algae extract aqueous solution; and (e) adding algae extract aqueous solution to target material from process (a).

To achieve the foregoing objective, the present invention provides a method for manufacturing a controlled release membrane, comprising following steps: (a) utilizing an algae extract to prepare an algae extract aqueous solution; (b) stirring the algae extract aqueous solution; and (c) adding algae extract aqueous solution to target material (e) adding an aqueous solution having divalent metal ion.

To achieve the foregoing objective, the present invention further provides another method for manufacturing a controlled release membrane, comprising following steps: (a) utilizing an algae extract to prepare an algae extract aqueous solution; (b) adding a surfactant to the algae extract aqueous solution; (c) stirring the algae extract aqueous solution; and (d) adding algae extract aqueous solution to target material (e) adding an aqueous solution having divalent metal ion.

In addition, another objective of the present invention is to utilize an algae extract, divalent metal ion, and inclusions to form a micro or nano size complex. The effect of stably controlled release is expected to achieve.

The primary objective of the present invention is to provide a method for manufacturing a tiny controlled release particle. An algae extract aqueous solution and an aqueous solution having divalent metal ion can be used to form a micro or nano size complex by cross-linking reaction, and the complex can be used in a different release condition by manufacturing the complex in a different process.

Therefore, to achieve the foregoing objective, the present invention provides a method for manufacturing a tiny controlled release particle, comprising following steps: (a) utilizing an algae extract to prepare an algae extract aqueous solution; (b) stirring the algae extract aqueous solution; and (c) adding an aqueous solution having divalent metal ion to the algae extract aqueous solution, wherein weight percentage of the algae extract is ranging from 0.2%-20% based on total weight of the algae extract aqueous solution.

To achieve the foregoing objective, the present invention further provides another method for manufacturing a tiny controlled release particle, comprising following steps: (a) utilizing an algae extract to prepare an algae extract aqueous solution; (b) adding a surfactant to the algae extract aqueous solution; (c) stirring the algae extract aqueous solution; and (d) adding an aqueous solution having divalent metal ion to the algae extract aqueous solution.

In addition, another objective of the present invention is to utilize an algae extract, divalent metal ion, and inclusions to form a micro or nano size complex. The effect of stably controlled release is expected to achieve.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is illustrated a flow diagram of manufacturing a tiny controlled release particle;

FIG. 2 is illustrated a preferred flow diagram of manufacturing a tiny controlled release particle;

FIG. 3 is illustrated a surface structure schematic diagram for tiny controlled release particle of the present invention;

FIG. 4 is illustrated another surface structure schematic diagram for tiny controlled release particle of the present invention;

FIG. 5 is illustrated a sectional structure schematic diagram for tiny controlled release particle of the present invention;

FIG. 6 is illustrated another sectional structure schematic diagram for tiny controlled release particle of the present invention;

FIG. 7 is a 10,000× scanning electron microscopy (SEM) image showing a surface structure of tiny controlled release particle of the present invention;

FIG. 8 is another 10,000× scanning electron microscopy (SEM) image showing a surface structure of tiny controlled release particle of the present invention;

FIG. 9 is illustrated a curve diagram for tiny controlled release particle of the present invention;

FIG. 10 is illustrated another curve diagram for tiny controlled release particle of the present invention;

FIG. 11 is a photograph showing that the tiny particle of the present invention exists in a solution with pH=2.2;

FIG. 12 is a photograph showing that the tiny particle of the present invention exists in a solution with pH=8, 9 and 10.

FIG. 13 is an illustration of the stage that apple snail and tea plant interact.

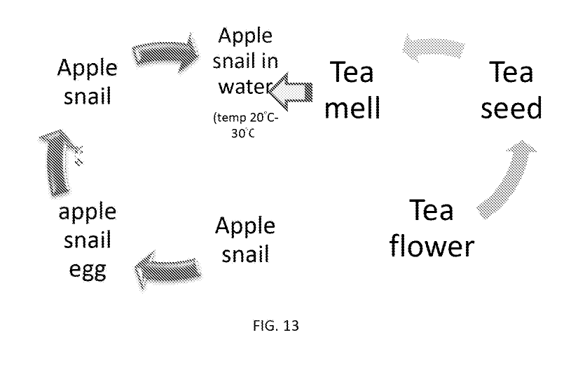

FIG. 14 is a graph of pH value in different treating days by BSC-21 and tea mill.

FIG. 15 is a graph of pH value in different treating days after exchanging water.

FIG. 16 is a graph of the measurement of concentration BSC-21 and TS-21 on different days.

FIG. 17 is a graph of measurement of concentration BSC-21 and TS-21 on different days after changing water without adding BSC-21 and TS-21

FIG. 18 is a graph of the measurement of the rice plant height at 15th day.

FIG. 19 is a photo of growth of rice seedlings right after treating with BSC-21, tea mills (TS21) and control.

FIG. 20A, FIG. 20B, FIG. 20C: are photos of the measurement of height of rice seedlings growth at 15th day after treating with BSC-21 and tea mills (TS-21).

### DETAILED DESCRIPTION OF THE PREFERRED EMBODIMENTS

Details of the objects, technical configuration, and effects of the present invention will be described more fully hereinafter with reference to the accompanying drawings, in which exemplary embodiments of the invention are shown. The like reference numerals indicate the like configuration throughout the specification, and in the drawings, the length and thickness of layers and regions may be exaggerated for clarity. The technical content of the present invention will become apparent by the detailed description of the following embodiments and the illustration of related drawings as follows. As used herein, the term “and/or” includes any and all combinations of one or more of the associated listed items.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

Some definitions:

Tiny particles: After the aqueous solution having divalent metal ion is added into the algae extract aqueous solution with emulsion shape, the algae extract is cross-linking immediately, and the microparticles or nanoparticles are formed, which is called tiny particles. The extent of cross-linking can be controlled by the reaction time between the aqueous solution having divalent metal ion and algae extract aqueous solution. In general, the purpose of cross-linking is to form a shell with mesh structure from the algae extract polymer. The tiny particle of the present invention may be cylindrical, spheroidal, elliptical, trigonal. The size of the tiny particle is 10 nm, 50 nm, 75 nm, 100 nm, 150 nm, 300 nm or any size within.

If time for cross-linking is shorter, such as 10 second to 5 min, the mesh structure of the tiny particle formed by algae extract polymer will be thinner, and the inclusions coated by the tiny particle of the present invention for sustained release will be sooner. This is called short-term release mechanism. On the contrary, if time for cross-linking is longer, such as 5 min-20 min, the condensed mesh structure of the tiny particle will be formed, and the inclusions coated by the tiny particle of the present invention for sustained release will be slower. That is called long-term release mechanism.

Surfactant: is an interface agent which can be anionic surfactant or a nonionic surfactant. Preferably, the anionic surfactant is a phospholipid.

One of object of the present invention is to provide a method for manufacturing a tiny controlled release particle. The process is described thereafter. The tiny particle can be used in a different release condition by manufacturing the particle in a different process. In addition, the size of tiny particle can be micrometer or nanometer, and depends on any needs for users.

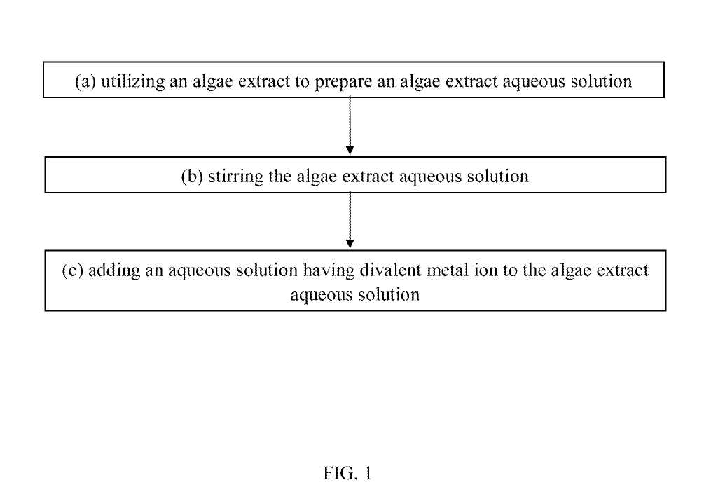

With reference to FIG. 1, there is illustrated a flow diagram of manufacturing a tiny controlled release particle. A method for manufacturing a tiny controlled release particle comprising the following steps: (a) utilizing an algae extract to prepare an algae extract aqueous solution; (b) stirring the algae extract aqueous solution; and (c) adding an aqueous solution having divalent metal ion to the algae extract aqueous solution; wherein, based on total weight of the algae extract aqueous solution, weight percentage of the algae extract is ranging from 0.2%-20%, preferably 1-5%.

There should be noted that, if weight percentage of the algae extract is more than 5-10% h, the algae extract aqueous solution would be too dense to stir. On the contrary, if weight percentage of the algae extract is less than 1%, the algae extract cannot cross-link with divalent metal ion. Based on total weight of the algae extract aqueous solution, weight percentage of the algae extract ranging from 1-5% can both achieve stirring easily and cross-linking well.

In this one embodiment, pH value of the algae extract aqueous solution in step (a) may be ranging from 5-7.

Wherein, the method may further comprise adding an alkaline solution to the algae extract aqueous solution before the step (b) to make the algae extract have better water solubility.

In addition, when the algae extract and the divalent metal ion are cross-linked, they may be partial or total reacted.

In this one embodiment, the alkaline solution is sodium hydroxide solution, and after adding the alkaline solution, pH value of the algae extract aqueous solution is maintained between 7.2-7.6, preferably 7.4.

In this one embodiment, the algae extract aqueous solution is stirred by a homogenizer, an ultrasonic oscillator, or a cell disruptor at step (b). The particle size may depend on intensity of stirring, and may range from nanometer to micrometer (2 mm-300 nm) In this embodiment, the equivalent concentration of the aqueous solution having divalent metal ion in step (c) is from 0.05-5N, preferably from 0.1-1N. Furthermore, the divalent metal ion is Mg²⁺, Ca²⁺, Cs²⁺, Ba²⁺ or combination thereof. After the aqueous solution having divalent metal ion is added into the algae extract aqueous solution with emulsion shape, the algae extract is cross-linking immediately, and the micro particles or nanoparticles are formed. The extent of cross-linking can be controlled by the reaction time between the aqueous solution having divalent metal ion and algae extract aqueous solution. In general, the purpose of cross-linking is to form a shell with mesh structure from the algae extract polymer. If time for cross-linking is shorter, such as 10 sec to 5 min, the mesh structure of the tiny particle formed by algae extract polymer will be thinner, and the inclusions coated by the tiny particle of the present invention for sustained release will be sooner. This is called short-term release mechanism. On the contrary, if time for cross-linking is longer, such as 5 min to 20 min, the condensed mesh structure of the tiny particle will be formed, and the inclusions coated by the tiny particle of the present invention for sustained release will be slower. That is called long-term release mechanism.

In one embodiment, the cross-linking time can be 10 seconds, 30 seconds, 1 minute, 2 minutes, 3 minutes, 4 minutes and 5 minutes for short-term release shell. In another embodiment, the cross-linking time can be 10 minutes, 15 minutes and 20 minutes for long-term release shell.

In the one embodiment of the present invention, the inclusions can be totally released within 2 hours or 3 hours in short-term release mechanism. However, the inclusions can be totally released more than 1 week, 2 weeks, 3 weeks and up to 10 weeks in long-term release mechanism. The effect can depend on the reaction time for cross-linking.

In addition, the present invention further provides another embodiment, which manufactures a tiny controlled release particle to meet the needs for users. This embodiment is described thereafter.

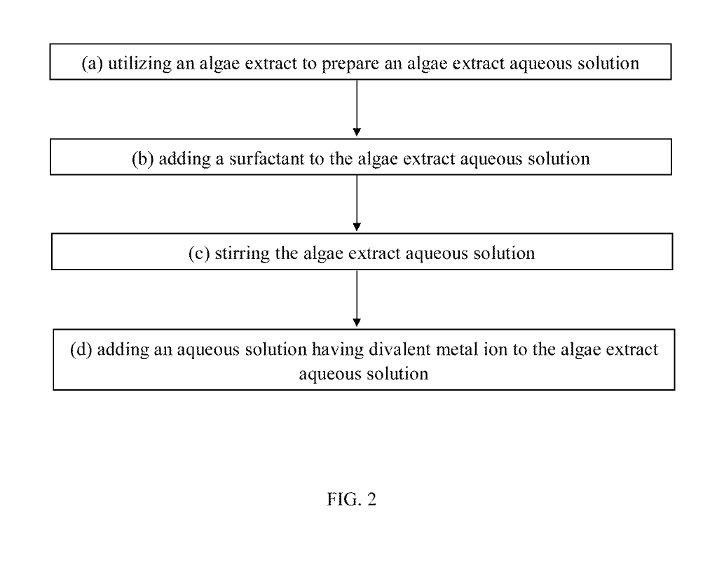

With reference to FIG. 2, there is illustrated a flow diagram of manufacturing a tiny controlled release particle. A method for manufacturing a tiny controlled release particle comprising the following steps: (a) utilizing an algae extract to prepare an algae extract aqueous solution; (b) adding a surfactant to the algae extract aqueous solution; (c) stirring the algae extract aqueous solution; and (d) adding an aqueous solution having divalent metal ion to the algae extract aqueous solution.

In this embodiment, pH value of the algae extract aqueous solution in step (a) may be ranging from 5, 5.5, 6, 6.5, and 7.

Wherein, the method may further comprise adding an alkaline solution to the algae extract aqueous solution before the step (b) to make the algae extract have better water solubility.

In this embodiment, the alkaline solution is sodium hydroxide solution, and after adding the alkaline solution, pH value of the algae extract aqueous solution is maintained between 7.2-7.6, preferably 7.4.

In one embodiment of the present invention, the surfactant is an anionic surfactant or a nonionic surfactant. Preferably, the anionic surfactant is a phospholipid. In addition, based on total weight of the algae extract aqueous solution, weight percentage of the surfactant is about 0.001 to 20%, preferably 0.1 to 10%. Particularly, aqueous phase substances and non-aqueous phase substances would distribute in distinct layers when the amount of surfactant is less 0.1%. On the contrary, the shell of tiny particle of the present invention would be too thick to release the inclusions unceasingly and smoothly when the amount of surfactant is more than 10%. Preferably, based on total weight of the algae extract aqueous solution, weight percentage of the surfactant ranging from 0.1 to 10%, does not merely maintain the algae extract aqueous solution homogenously but also keep the shell of tiny particle on suitable thickness.

In one embodiment, the algae extract aqueous solution is stirred by a homogenizer, an ultrasonic oscillator, or a cell disruptor at step (c). The particle size may depend on intensity of stirring, and may range from nanometer to micrometer, in one embodiment, the size is 300 nm.

Preferably, based on total weight of the algae extract aqueous solution, weight percentage of the algae extract is ranging from 0.2% to 20%, preferably 1 to 5%. There should be noted that, the algae extract aqueous solution would be too dense to stir if weight percentage of the algae extract is too high. On the contrary, the algae extract cannot cross-link with divalent metal ion if weight percentage of the algae extract is too low. Based on total weight of the algae extract aqueous solution, weight percentage of the algae extract ranging from 1-5% can both achieve stirring easily and cross-linking well.

In this embodiment, the equivalent concentration of the aqueous solution having divalent metal ion in step (d) is from 0.05 to 5N, preferably from 0.1 to 1N.

Furthermore, the divalent metal ion is Mg²⁺, Ca²⁺, Cs²⁺, Ba²⁺ or combination thereof. After the aqueous solution having divalent metal ion is added into the algae extract aqueous solution with emulsion shape, the algae extract is cross-linking immediately, and the microparticles or nanoparticles are formed. The extent of cross-linking can be controlled by the reaction time between the aqueous solution having divalent metal ion and algae extract aqueous solution. In general, the purpose of cross-linking is to form a shell with mesh structure from the algae extract polymer. If time for cross-linking is shorter, such as 10 sec-5min, the mesh structure of the tiny particle formed by algae extract polymer will be thinner, and the inclusions coated by the tiny particle of the present invention for sustained release will be sooner. This is called short-term release mechanism. On the contrary, if time for cross-linking is longer, such as 5 min-20 min, the condensed mesh structure of the tiny particle will be formed, and the inclusions coated by the tiny particle of the present invention for sustained release will be slower. That is called long-term release mechanism. In this preferred embodiment of the present invention, the inclusions can be totally released by tiny particles with surfactant within one hour in short-term release mechanism. However, the inclusions can be totally released by tiny particles with surfactant more than 10 weeks in long-term release mechanism. This effect brings an unexpected result.

Furthermore, the present invention still provides a tiny particle used for controlled release, comprising an algae extract and a divalent metal ion.

In the one embodiment, the algae extract may be a biodegradable material, and may comprise a polymer material and a carbohydrate.

In the preferred embodiment, the main component of the algae extract is alginate, and preferably sodium alginate or potassium alginate. However, sodium alginate or potassium alginate is exemplary, but not limited thereto. Most contents of algae extracts can be well used in the present invention.

In addition, the divalent metal ion is Mg²⁺, Ca²⁺, Cs²⁺, Ba²⁺ or combination thereof.

Further, the tiny particle used for controlled release in the present invention further comprises a surfactant, which is an anionic surfactant or a nonionic surfactant. Preferably, the anionic surfactant is a phospholipid. In addition, based on total weight of the algae extract aqueous solution, weight percentage of the surfactant is about 0.001-20%, preferably 0.1-10%. Particularly, aqueous phase substances and non-aqueous phase substances would distribute in distinct layers when the amount of surfactant is below 0.1%. On the contrary, the shell of tiny particle of the present invention would be too thick to release the inclusions unceasingly and smoothly when the amount of surfactant is about 10%. Preferably, based on total weight of the algae extract aqueous solution, weight percentage of the surfactant ranging from 0.1-10% would not merely maintain the algae extract aqueous solution homogenously but also keep the shell of tiny particle on suitable thickness.

In one embodiment, the tiny particle of the present invention may be cylindrical, spheroidal, elliptical, trigonal, and so on.

In one embodiment, the tiny particle is able to exist in an environment with pH range from 2.2 to 9.

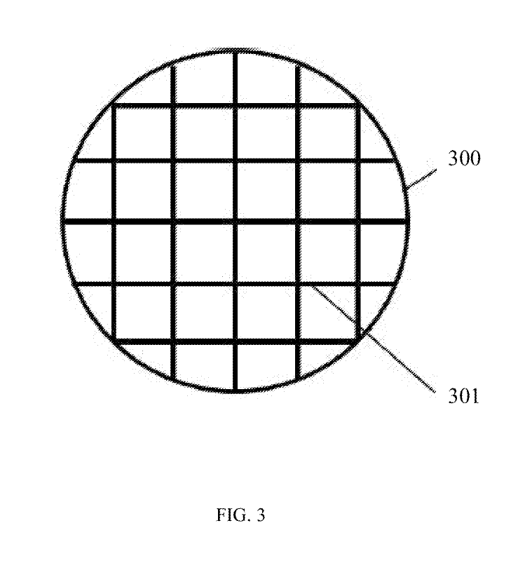

With reference to FIG. 3, there is illustrated a surface structure schematic diagram for tiny controlled release particle of the present invention. Referring to FIG. 3, the tiny particle 300 of the present invention has a shell 301 with mesh structure, which is formed by cross-linking with divalent metal ion (not shown). FIG. 3 can be regarded as a short-term release mechanism schematic diagram of tiny particle 300. The shell 301 with mesh structure may be thinner and the interval between meshes within the shell 301 is a micrometer sized mesh structure. If users need to release inclusions (not shown) soon, this tiny particle 300 can meet the need for releasing inclusions (not shown) and achieve the desired results.

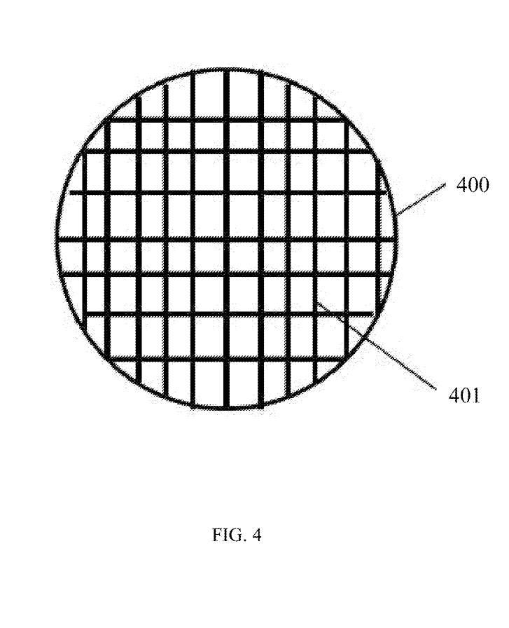

With reference to FIG. 4, there is illustrated another surface structure schematic diagram for tiny controlled release particle of the present invention. Referring to FIG. 4, the tiny particle 400 of the present invention has a shell 401 with mesh structure, which is formed by cross-linking with divalent metal ion (not shown). FIG. 4 can be regarded as a long-term release mechanism schematic diagram of tiny particle 400. The shell 401 with mesh structure may be thicker and the interval between meshes within the shell 401 is a nanometer or micrometer sized mesh structure. If users need to release inclusions (not shown) slowly, that tiny particle 400 can meet the need for releasing inclusions (not shown) and achieve the desired results.

There should be noted that, FIGS. 3 and 4 are the surface structure schematic diagrams for tiny controlled release particle of the present invention. The tiny particle of the present invention depending on the extent of cross-linking the algae extract can have long-term release effect or short-term release effect. Moreover, the extent of cross-linking the algae extract also depends on the time for cross-linking.

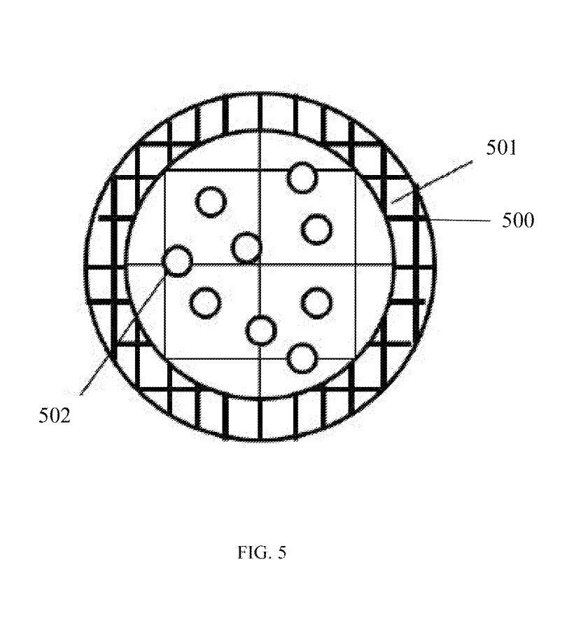

With reference to FIG.5, there is illustrated a sectional structure schematic diagram for tiny controlled release particle of the present invention. Referring to FIG. 5, the tiny particle 500 of the present invention has a shell 501 with mesh structure. As mentioned above, the shell 501 with mesh structure may be thinner or thicker. If thinner, it should be similar with the schematic diagram shown in FIG. 3. If thicker, it should be similar with the schematic diagram shown in FIG. 4. Wherein, the inclusion 502 is coated in the tiny particle 500 of the present invention, and the inclusion 502 is a hydrophilic material.

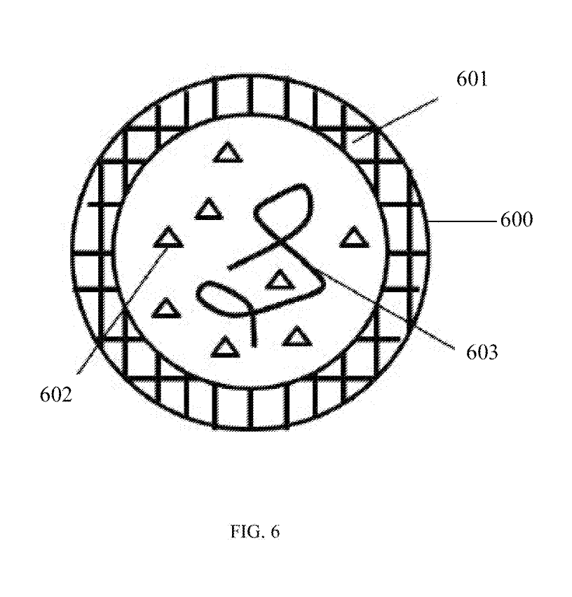

With reference to FIG.6, there is illustrated another sectional structure schematic diagram for tiny controlled release particle of the present invention. Referring to FIG. 6, the tiny particle 600 of the present invention has a shell 601 with mesh structure. Also, the shell 601 with mesh structure may be thinner or thicker. If thinner, it should be similar with the schematic diagram shown in FIG. 3. If thicker, it should be similar with the schematic diagram shown in FIG. 4. Wherein, the tiny particle 600 of the present invention is a hydrophilic material, and in order to coated the hydrophobic material, such as inclusion 602, and release it stably, a surfactant 603 can also be coated into the tiny particle 600. In other words, the surfactant 603 is capable of making the tiny particle 600 coat with inclusion 602 and releases it stably. Preferably, the surfactant is an anionic surfactant or a nonionic surfactant. In the preferred embodiment, the anionic surfactant is a phospholipid.

There should be noted that, the tiny particle 600 coating with the surfactant 603 has better long-term release effect than that without the surfactant 603. In this preferred embodiment, the time for controlled and sustained release can be longer than 10 weeks, which is an unexpected result.

Furthermore, to enable any person skilled in the art to understand the characteristics the tiny controlled release particle of the present invention, the following preferred embodiments are shown to support the characteristics the tiny controlled release particle of the present invention. Here, it is to be understood that the general description are exemplary and explanatory only and the disclosure should be construed as limited only by the scope of the claims.

It should be noted that, the following experimental results are expected to clearly expound the characteristics of the present invention but not expected to restrict the scope of the present invention. Any limitations for the scope of the present invention should be defined by the appended claims and their equivalents.

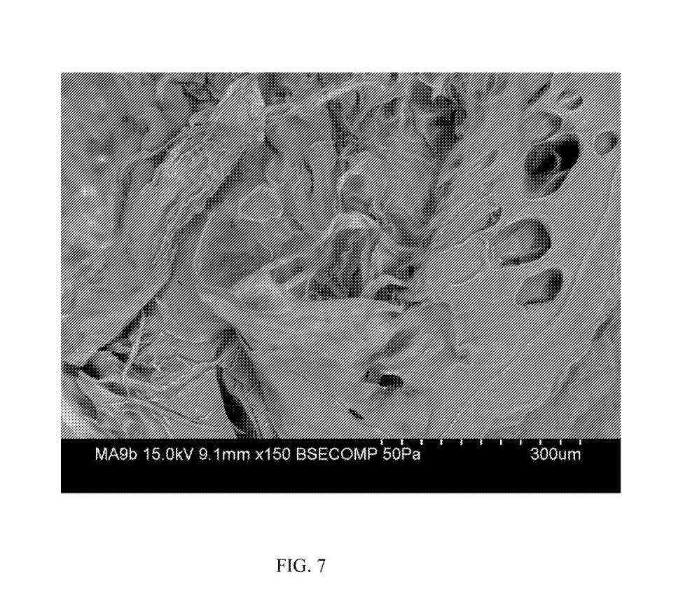

With reference of FIG. 7, there is a 10,000× scanning electron microscopy (SEM) image showing a surface structure of tiny controlled release particle of the present invention. This tiny particle is obtained from the flow diagram of FIG. 1 and cross-linking for 5 minutes, and the surfactant is not added. Referring to FIG. 7, the porous structure is filled with the surface of tiny particle. In addition, the average pore size at the surface of tiny particle is estimated about 75 μm.

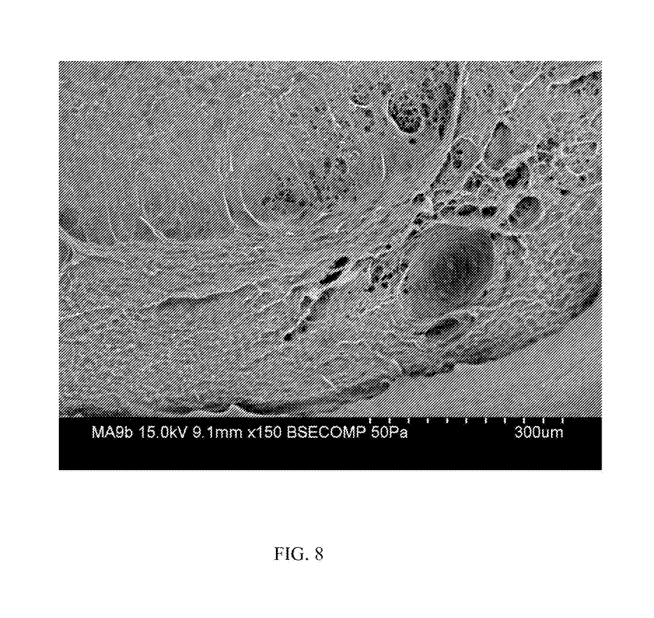

With reference of FIG. 8, there is another 10,000× scanning electron microscopy (SEM) image showing a surface structure of tiny controlled release particle of the present invention. This tiny particle is obtained from the flow diagram of FIG. 2 and cross-linking for 5 minutes, and the surfactant is added. Based on the total weight of the algae extract aqueous solution, the weight percentage of the surfactant is about 1%. Referring to FIG. 8, the average pore size at the surface of tiny particle is estimated about or smaller than 15 μm. Accordingly, compared with FIG. 7, after the surfactant is added, the surface of tiny particle has smaller pore size, which enables the inclusion to be released slower. Thus, this effect brings an unexpected result.

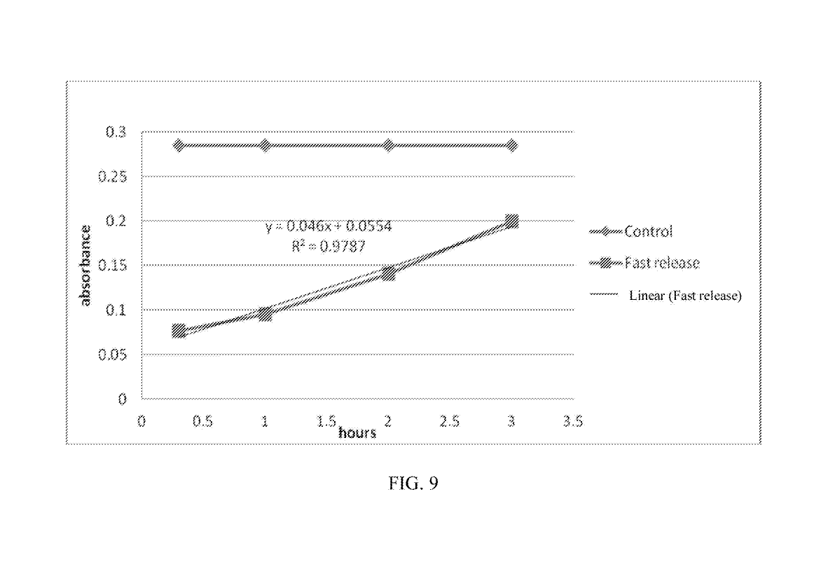

With reference to FIG. 9, there is illustrated a curve diagram for tiny controlled release particle of the present invention. Referring to FIG. 9, a top straight line with rhombus dots is the absorbance of the control group, at this time; the tiny particles without any inclusions are in 50 mL water. Based on FIG. 9, the absorbance of the control group from 0.5 hr to 3 hrs almost keeps on 0.2847. On the contrary, another curve with rectangular dots is the absorbance of the controlled release group (experimental group), which is observed from the tiny particle coated with the pigment, and the absorbance increases with lapse of time. The condition for controlled release group experiment is that, the tiny particles coated with 250 μL pigments are added into 50 mL water, and then release the pigment unceasingly. Based on FIG. 9, when the encapsulated tiny particles completely release the pigment, the absorbance is supposed to reach 0.2847. The analysis from the trend line (solid line without rectangular dots) shows that the pigment can be released completely after about 6hrs. It should be noted that, this preferred embodiment provides the tiny particles without the surfactant, and the release rate of this tiny particle is about 40-50 μL/hr.

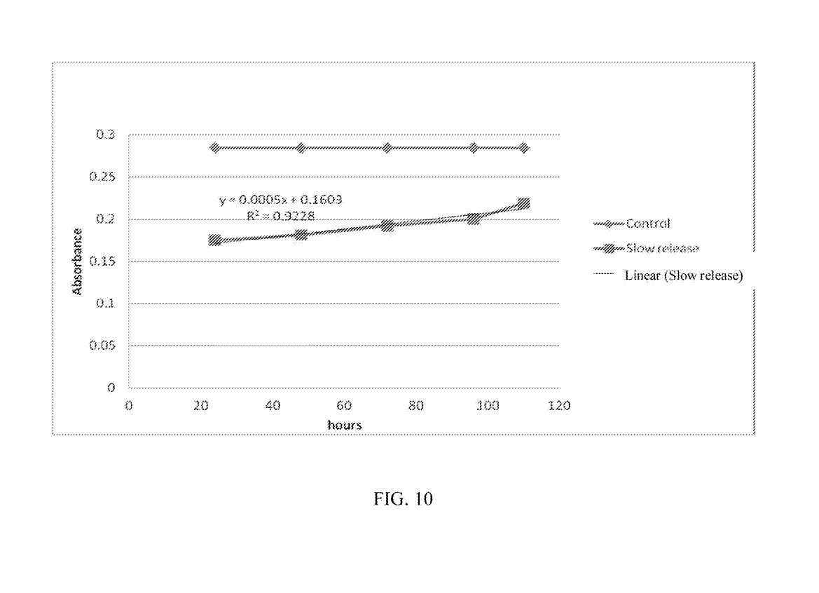

With reference to FIG. 10, there is illustrated another curve diagram for tiny controlled release particle of the present invention. Referring to FIG. 10, a top straight line with rhombus dots is the absorbance of the control group, at this time; the tiny particles without any inclusions are in 50 mL water. Based on FIG. 10, the absorbance of the control group from 24 hrs to 110 hrs almost keeps on 0.2847. On the contrary, another curve with rectangular dots is the absorbance of the controlled release group (experimental group), which is observed from the tiny particle coated with the pigment, and the absorbance increases with lapse of time. The condition for controlled release group experiment is that, the tiny particles coated with 250 μL pigments are added into 50 mL water, and then release the pigment unceasingly. Based on FIG. 10, when the encapsulated tiny particles release the pigment completely, the absorbance is supposed to reach 0.2847. The analysis from the trend line (solid line without rectangular dots) shows that the pigment can be released completely after about 248 hrs. It should be noted that, this preferred embodiment provides the tiny particles coating with the surfactant, and the release rate of this tiny particle is about 0.8-1.2 μL/hr.

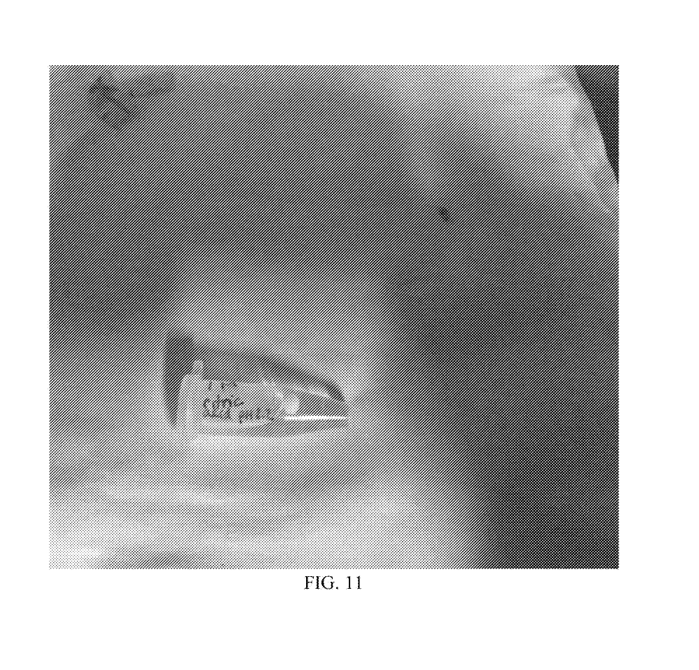

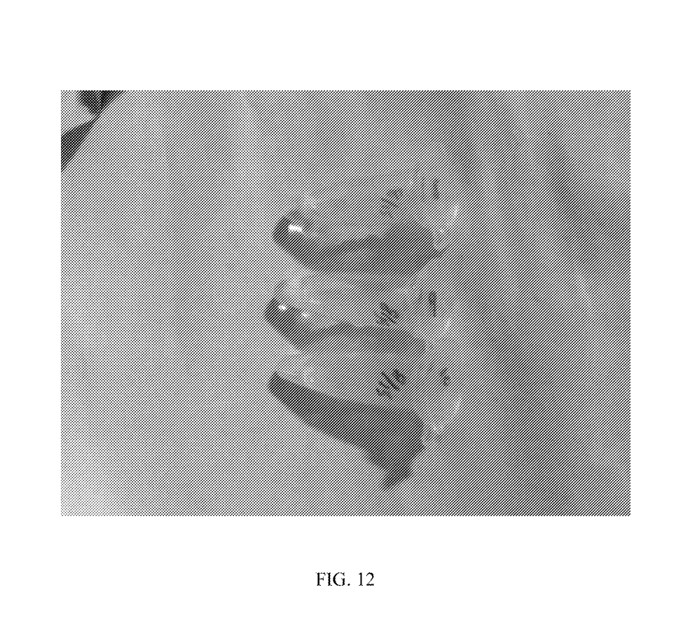

With reference to FIG. 11, there is a photograph showing that the tiny particle of the present invention exists in a solution with pH=2.2. Furthermore, with reference to FIG. 12, there is a photograph showing that the tiny particle of the present invention exists in a solution with pH=8-10. Wherein, this preferred embodiment provides the tiny particle coating with the surfactant. Referring to FIGS. 11 and 12, when the tiny particle coating with the surfactant is added into the solutions with pH=2.2, 8, or 9, the white particles can be observed within those solutions after 24 hours. However, when the tiny particle coating with the surfactant is added into the solution with pH=10, the white particles hydrolyze after some hours. Accordingly, the tiny particle coating with the surfactant of the present invention is able to exist in the environment of pH=2.2 to 9. For example, the tiny particle used for coating with fertilizer can exist in acid soil and alkaline soil, and the characteristics for acid resistance and alkaline resistance explains that the tiny particle can exist in acid and alkaline solution, and release the fertilizer stably. In particular, the pH range of acidic rain is 4-5, the tiny particle can still exist and release inclusions stably in this environment, which explains the advantages and long-felt need of the present invention. However, those uses are merely exemplary, but not restricted. Any limitations for the scope of the present invention should be defined by the appended claims and their equivalents.

To sum up, a tiny controlled release particle of the present invention has the following advantages:

(1) When the algae extract and the divalent metal ion are cross-linking, they may be partial or total reacted.

(2) The tiny particle is able to coat with water insoluble (hydrophobic) inclusions.

(3) The time for cross-linking is very short.

(4) If the surfactant is added, the time for releasing the inclusions can be longer. The effect for sustained release inclusions in longer time can be achieved.

(5) The tiny particle without the surfactant and with the surfactant can release inclusions steadily more than 4 weeks and 10 weeks, respectively. Therefore, this effect achieves long-felt need in market.

The embodiments and the technical principles used are described above. All variations and modifications of the present invention and the uses thereof are included in the scope of the present invention if they do not depart from the spirit of the disclosure of this specification and drawings.

In one embodiment, the present invention can be used for biological pesticide and fertilizer in agriculture and farming business. The example below is the used for controlled release of a biological pesticide which comprises tiny particle and a proprietary product.

In another embodiment, the present invention can be used for delivery of cosmetic and skin care materials.

In yet another embodiment, the present invention can be used for pharmaceutical drug delivery, food delivery, seed business.

### WORKING EXAMPLE

The experiment tests the rice plant growth by treating TS-21, a tea extract of tea mill (as pesticide), and treating of BSC-21, a proprietary biological pesticide packaged with tiny particle of present invention.

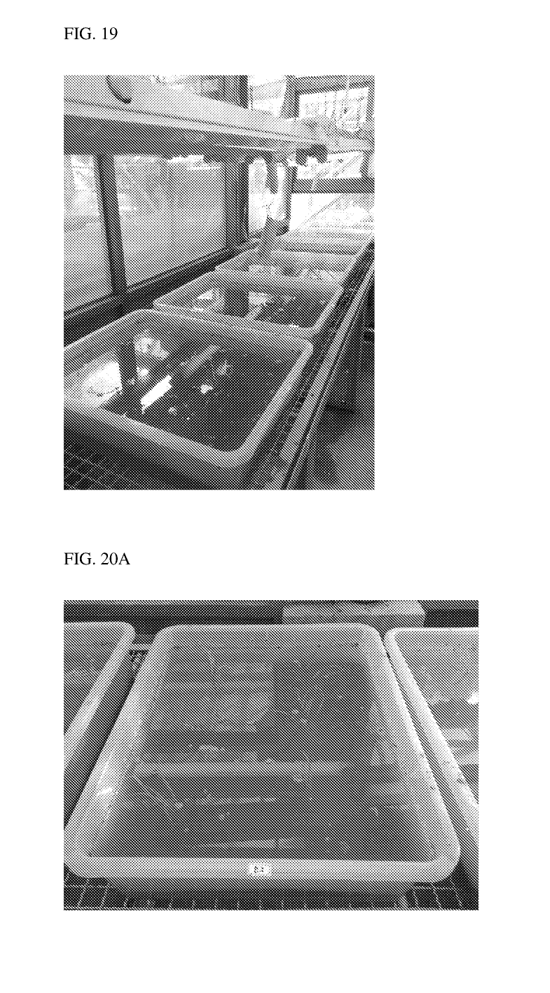

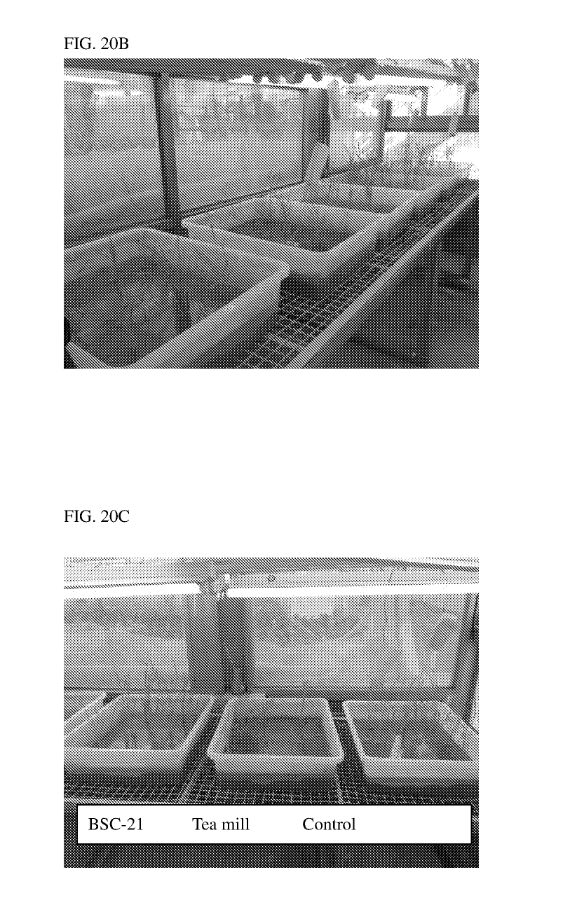

Put the soil (Height=5 cm) into the plastic basin (Length: Width: Height=58: 52: 15 cm), and poured the water up to 2 cm height from the soil surface. Planted the seedling of rice, and placed in the greenhouse (25° C.) (FIG. 19). There were 3 repeats for 3 treating groups (BSC-21, extracts of tea mill and control). Individually, added the BSC-21 (1 g) and extracts of tea seed kernel (1.6 g) at the start (0 day). 30 ml water of each group was filtered, and their pH value and the concentration of pesticides (TS 21 and BSC 21) in the water were measured daily from 1st to 8th days. At 9th day (new 0 day), pumped original water, and poured new water into the basin to the height of 2 cm. Repeated the foregoing methods to measure the pH value and concentration of TS-21 daily from 10th to 17th days (new 1st-8th days). At 15th day, measure the height of rice seedling growth (FIGS. 20A-20C).

pH value was measured by pH meter (SUNTEX, Taipei, Taiwan). TS-21 quantity was calculated by regression curve from OD value and standard. OD value was detected (548 nm) by the spectrophotometer (THEROM, Calif., USA) (Luo et al., 2011). All statistical analyses were analyzed by one-way ANOVA (PROC GLM) and Tukey's studentized range (HSD) (Version 8. SAS Institute Inc., Cary, N.C., USA 1999).

Results

1. pH value

1.1. pH in different treating days

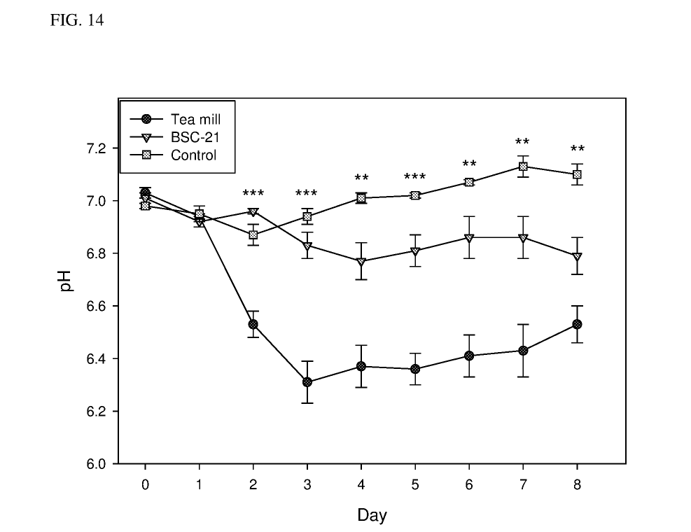

The pH value of tea mill was significant low at the 2nd day, but BSC-21 was no different on pH comparing with Control's pH value (FIG. 14).

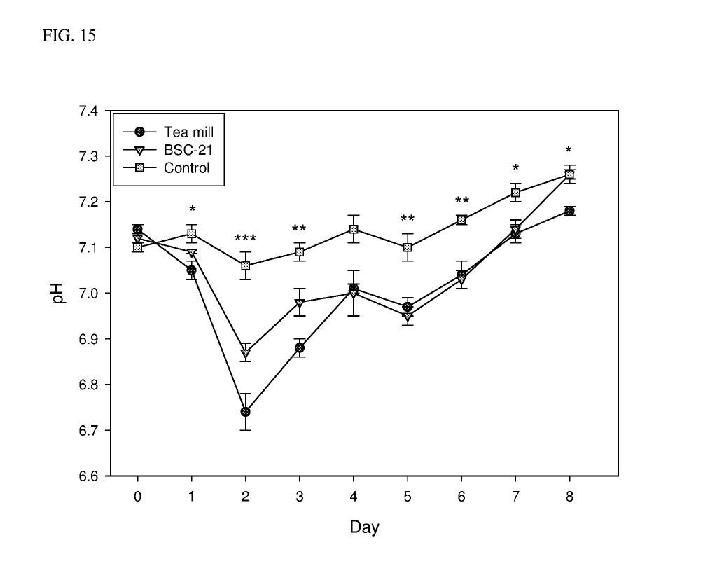

1.2. pH in different treating days after exchanging water (FIG. 15)

BSC-21 and tea mill were similar until new 8th day. The pH of tea mill was significant lower than BSC-21 and control at new 8th day.

2. Releasing of TS-21

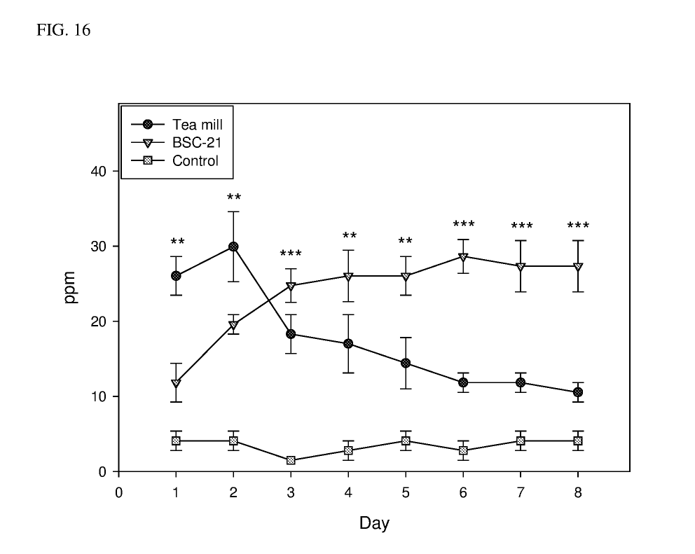

2.1. Concentration of TS-21 in different treating days (FIG. 16)

The releasing effect of BSC-21 in a tiny particle and and releasing effect of TS-21 by measuring their concentration in water in different treating days. TS-21 of tea mill release was peaked at 2nd days (29.92±4.66 ppm), then it decreased from 3rd day and then leveled off from 4th to 8th day. BSC-21 showed its release concentration increased (26.04±2.58 ppm) and continued higher thanTS-21 of tea mill (14.42±3.42 ppm) from 5th day.

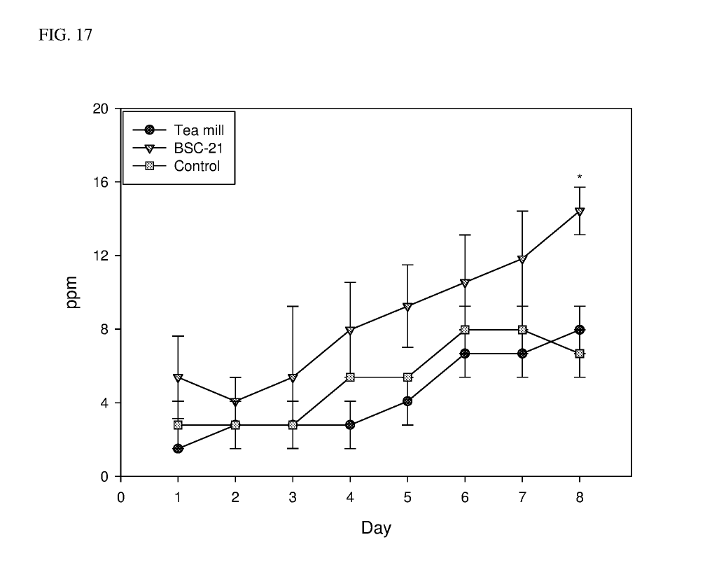

2.2. Concentration of BSC 21 and TS-21 in different days after exchanging water (FIG. 17)

BSC-21 and tea mill (TS 21) were not added after exchanging water. Measurement of the new exchanged water in the plant basin showed that the concentration of TS-21 were significantly low (<15 ppm), whereas BSC-21 concentration was rising gradually and maintained at a significantly higher level (14.42±1.29 ppm) than the tea mill (7.96±1.29 ppm) at new 8th day, Indicating the controlled efficient release of the BSC21 from the tiny particle.

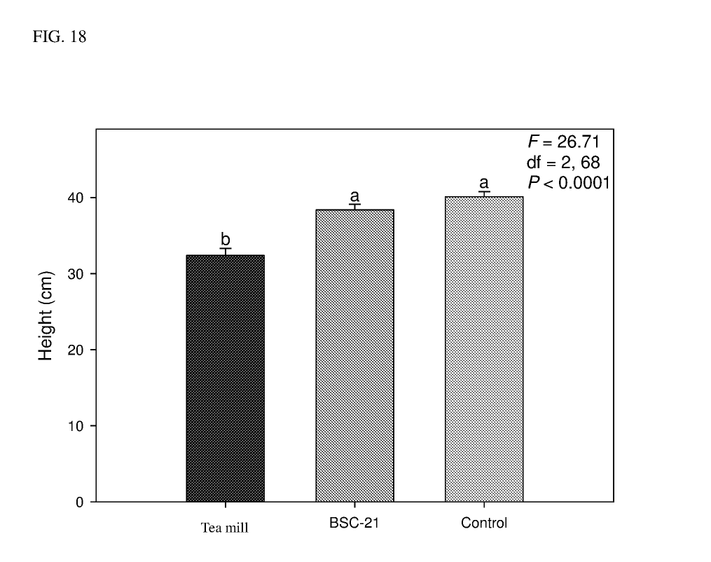

3. Rice height at 15th day (FIG. 18)

The height in BSC-21 and control were similar, but tea mill group was significant low than others which indicates that the system controlled release can effectively sustain in the rice field (to kill the snail for example), while it does not cause the toxic effect to inhibit the rice growth and production.

References herein each of which is incorporated in their entireties.

Luo, X. W., Shen J. F., Xiao R. X.,Chen Z. H. 2011. Determination of secondary metabolism in extracts from fruit shell of Camellia oleifera Abel. Science and Technology of Food Industry 11: 451-453. (in Chinese)

SAS Institute, 1999. User's manual, version 8.0. SAS Institute, Cary, N.C., USA.

What is claimed is:

1. A method for manufacturing a tiny controlled release particle, comprising mixing algae extract aqueous solution and an aqueous solution having divalent metal ion to the algae extract aqueous solution.

2. The method of claim 1, wherein the method further comprises adding an alkaline solution to the algae extract aqueous solution before adding the aqueous solution.

3. The method of claim 2, wherein the alkaline solution is sodium hydroxide solution.

4. The method of claim 2, wherein the alkaline solution is added to maintain pH value of the algae extract aqueous solution ranging from 7.2-7.6.

5. The method of claim 1, wherein the algae extract aqueous solution is stirred by a homogenizer, an ultrasonic oscillator, or a cell disruptor.

6. The method of claim 1, wherein the divalent metal ion is Mg²⁺, Ca²⁺, Cs²⁺, Ba²⁺ or combination thereof.

7. The method of claim 6, wherein equivalent concentration of the aqueous solution having divalent metal ion is ranging from 0.05-5N.

8. The method of claim 1, wherein reaction time for the aqueous solution having divalent metal ion and the algae extract aqueous solution is 10 seconds to 5 minutes.

9. The method of claim 1, wherein the weight percentage of the algae extract is ranging from 0.2%-20% based on the total weight of the algae extract aqueous solution.

10. The method of claim 1, wherein pH value of the algae extract aqueous solution is ranging from 5-7.

11. A tiny particle for controlled release, comprising an algae extract and a divalent metal ion.

12. The tiny particle of claim 11, wherein periphery of the tiny particle forms a structure with fiber mesh.

13. The tiny particle of claim 11, wherein the algae extract comprises a polymer material and a carbohydrate.

14. The tiny particle of claim 11, wherein the algae extract is a biodegradable material.

15. The tiny particle of claim 11, wherein the divalent metal ion is Mg²⁺, Ca²⁺, Cs²⁺, Ba²⁺ or combination thereof.

16. The tiny particle of claim 11, further comprising a surfactant.

17. The tiny particle of claim 16, wherein the surfactant is an anionic surfactant or a nonionic surfactant.

18. The tiny particle of claim 17, wherein the anionic surfactant is a phospholipid.

19. The tiny particle of claim 16, wherein the tiny particle exists in an environment with pH 2.2-9.

20. A method for manufacturing a tiny controlled release particle, comprising following steps:
(a) utilizing an algae extract to prepare an algae extract aqueous solution;
(b) adding a surfactant to the algae extract aqueous solution;
(c) stirring the algae extract aqueous solution; and
(d) adding an aqueous solution having divalent metal ion to the algae extract aqueous solution.
